(19) United States
(12) Patent Application Publication
(10) Pub. No.: US 2013/0205266 A1
(43) Pub. Date: Aug. 8, 2013

(54) COLORING/GROUPING PATTERNS FOR MULTI-PATTERNING

(71) Applicants: Wen-Hao Chen, Hsin-Chu City (TW); Yuan-Te Hou, Hsinchu City (TW); Yi-Kan Cheng, Taipei (TW)

(72) Inventors: Wen-Hao Chen, Hsin-Chu City (TW); Yuan-Te Hou, Hsinchu City (TW); Yi-Kan Cheng, Taipei (TW)

(73) Assignee: Taiwan Semiconductor Manufacturing Co.,Ltd., Hsin-Chu (TW)

(21) Appl. No.: 13/365,546

(22) Filed: Feb. 3, 2012

(51) Int. Cl. G06F 17/50

(52) U.S. Cl. 716/55

(57) ABSTRACT

A method comprises: accessing a persistent, machine readable storage medium containing data representing an integrated circuit (IC) design to be fabricated using multi-patterning; identifying at least one network of conductive patterns configured to transmit signals that substantially impact timing of at least one circuit in the IC; pre-grouping the at least one network of conductive patterns in a first group; and electronically providing data to an electronic design automation (EDA) tool to cause inclusion in a first single photomask of all portions of the patterns within the first group that are to be formed in a single layer of the IC, wherein the single layer is to be multi-patterned using at least two photomasks.

### FIELD

This disclosure relates to layout of integrated circuit (IC) patterns for use in multi-patterning methods.

### BACKGROUND

In semiconductor fabrication processes, the resolution of a photoresist pattern begins to blur at about 45 nanometer (nm) half pitch. To continue to use fabrication equipment purchased for larger technology nodes, double exposure methods have been developed.

Multiple exposure or multi-patterning (MPT) involves forming patterns on a single layer of a substrate using two or more different masks in succession. If only two masks are used for patterning a layer, the technique is referred to as double exposure. One form of double exposure is referred to as double patterning technology (DPT). In DPT, first and second masks are used sequentially to pattern the same layer. As long as the patterns within each mask comply with the relevant minimum separation distances for the technology node, the combination of patterns formed using both masks may include smaller separations. DPT allows line segments, and in some cases, vertexes (angles) to be formed of a vertical segment and a horizontal segment on the same mask. Thus, DPT generally allows for greater reduction in overall IC layout.

DPT is a layout splitting method analogous to a two coloring problem for layout splitting in graph theory. If two masks are to be used, it is customary to refer to the patterns as being assigned one of two “color types”, where the color corresponds to a photomask assignment.

One result of using MPT is that, for a given layout and process, the total number of photomasks increases. An increase in the number of photomasks can increase the cost of fabricating an IC.

### BRIEF DESCRIPTION OF THE DRAWINGS

FIGS. 1A-1C are diagrams showing how spacing between adjacent patterns may be affected by mask misalignment.

FIG. 2 is a schematic diagram of the pre-grouping of networks carrying timing-critical signals.

FIG. 3A schematically shows networks of conductive patterns assigned to two groups (or colors).

FIG. 3B shows an IC patterned by DPT to include both sets of patterns shown in FIG. 3A.

FIG. 4 is a flow chart of a DPT method for pre-grouping patterns to be formed by MPT.

FIG. 5 is a schematic plan view of an IC having function cells and spare cells and for which the patterns are formed by MPT.

FIG. 6 is a flow chart of a DPT method for implementing a design change in the IC of FIG. 5.

FIG. 7 is a flow chart of another DPT method for implementing a design change in the IC of FIG. 5.

FIG. 8 is a diagram schematically showing a networks of conductive patterns assigned to be multi-patterned according to the method of FIG. 7.

FIG. 9 is a block diagram of a system for performing the methods of FIGS. 1-8.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

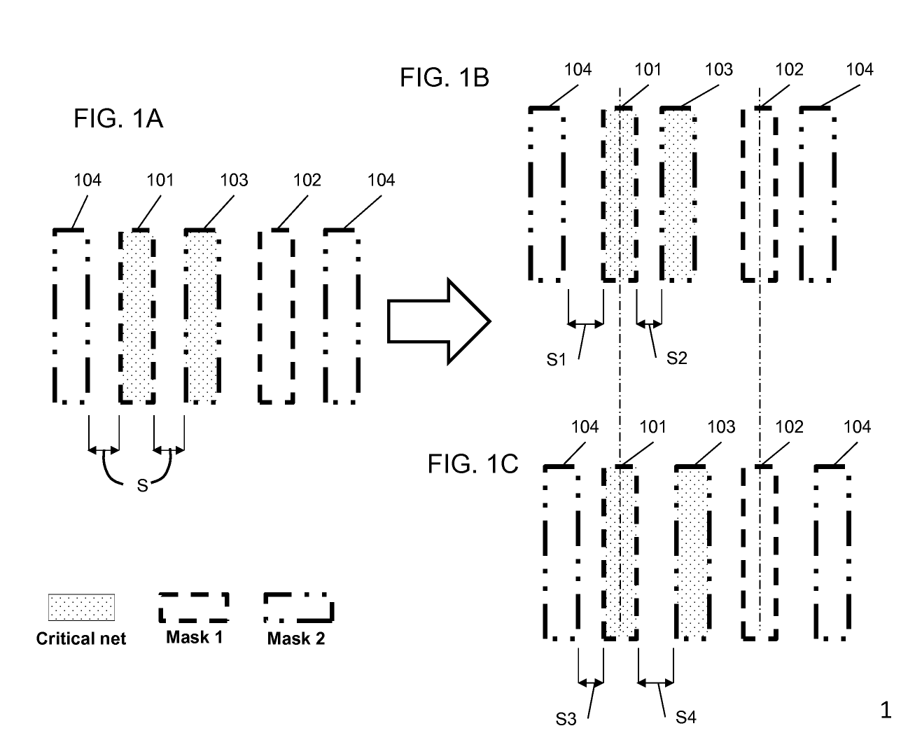

FIGS. 1A-1C show a plurality of patterns to be formed by an MPT method. For ease of illustration, the examples discussed below are DPT methods using two photomasks per layer. The methods are also applicable to MPT methods using three or more masks per layer.

FIG. 1A shows a set of patterns in an IC design. The patterns include timing critical patterns 101, 103, and non timing-critical patterns 102, 104. The patterns are assigned to first and second photomasks, such that patterns 101 and 102 are assigned to the first photomask, and patterns 103 and 104 are assigned to the second photomask. Any two adjacent patterns on the IC layer separated by a distance less than the minimum separator distance for single mask photolithography are formed on different masks from each other (i.e., assigned different colors). In this simplified example, each of the patterns 101-104 is separated from the adjacent patterns by the same distance S.

FIGS. 1B and 1C show possible effects of misalignment between the second photomask and the patterns formed by the first photomask. As indicated by the dashed lines connecting FIGS. 1B and 1C, patterns 101 and 102 are formed by a single mask, so the spacing between them is unaffected by misalignment between mask exposures. In FIG. 1B, the second mask is shifted left relative to the first mask, so that patterns 101 and 104 are separated by a larger distance 51 than the design distance S, and patterns 101 and 103 are separated by a smaller distance S2 than the design distance S. In FIG. 1C, the second mask is shifted right relative to the first mask, so that patterns 101 and 104 are separated by a smaller distance S3 than the design distance S, and patterns 101 and 103 are separated by a larger distance S4 than the design distance S. Changes in the distance between adjacent lines affect the capacitive and/or inductive couplings between the lines. Such changes may affect the transmission time of signals transmitted over these lines. Thus, mask misalignment may make it difficult to predict and/or control the timing of timing-critical signals and impact device functionality. For example, in technology nodes of 20 nm or smaller, these effects may be significant in multi-patterned ICs.

In some embodiments, for MPT routing purposes, an EDA tool is provided with mask decomposition information, allowing some critical nets issues caused by mask misalignment to be controlled in the design stage. In some embodiments, pre-grouping and/or pre-coloring information is provided to the place and route engine of the EDA tool and applied prior to routing.

As used herein, “pre-grouping” refers to selecting two or more patterns that are to be formed using the same photomask as each other. The pre-grouping information is provided to the EDA tool. In an MPT method using two or more masks to expose a given layer of the IC, pre-grouped patterns may be assigned any “color”, so long as they have the same color as each other.

As used herein, “pre-coloring” refers to assigning one or more patterns to a particular color or photomask. Thus pre-coloring allows the designer or foundry to specify that a first pattern or group of patterns is assigned to a particular mask that is used to form another particular pattern or group of patterns. Pre-coloring may be used to cause two groups of patterns to be on the same mask as each other, or on different masks from each other.

In some embodiments, for clock distribution network (or clock tree), complete or partial clock tree nets are assigned to same group by pre-grouping. This causes the router to lay out the patterns in the same mask during the MPT decomposition. Locating the clock distribution network on the same mask can avoid synchronization problems due to misalignment between adjacent patterns within the clock distribution network. (In some cases, the router may automatically increase the spacing between adjacent patterns of the pre-grouped patterns, to allow them to be formed using a single mask).

In some embodiments, in addition to the clock distribution network, neighboring wires adjacent to the clock distribution network patterns are optionally included in the same group by pre-grouping. This ensures that the clock distribution patterns at the periphery of the network have predictable capacitive couplings to the neighboring patterns.

In some embodiments, other timing/skew critical networks are pre-grouped in a similar fashion. Such timing critical networks may include high speed networks, real time networks, differential signal networks, and the system bus. For this purpose, patterns within the pre-grouped networks are assigned to the same mask as each other.

Further, for other application specific IC designs, timing sensitive networks may also be pre-grouped. For example, networks controlling timing of register-to-register or latch-to-latch transfers may be pre-grouped with timing critical signal carrying lines, so that hold violations and setup violations in the latches are avoided.

In some embodiments, all of the timing-critical networks are pre-colored with the same color, so that within a given layer of the IC all timing-critical patterns are formed by the same photomask. In other embodiments, all of the timing-critical networks are pre-grouped, but not pre-colored, so that within a given layer of the IC each timing-critical network has its patterns formed by the same photomask (but some of the networks may have their patterns formed on a different photomask than other timing critical networks).

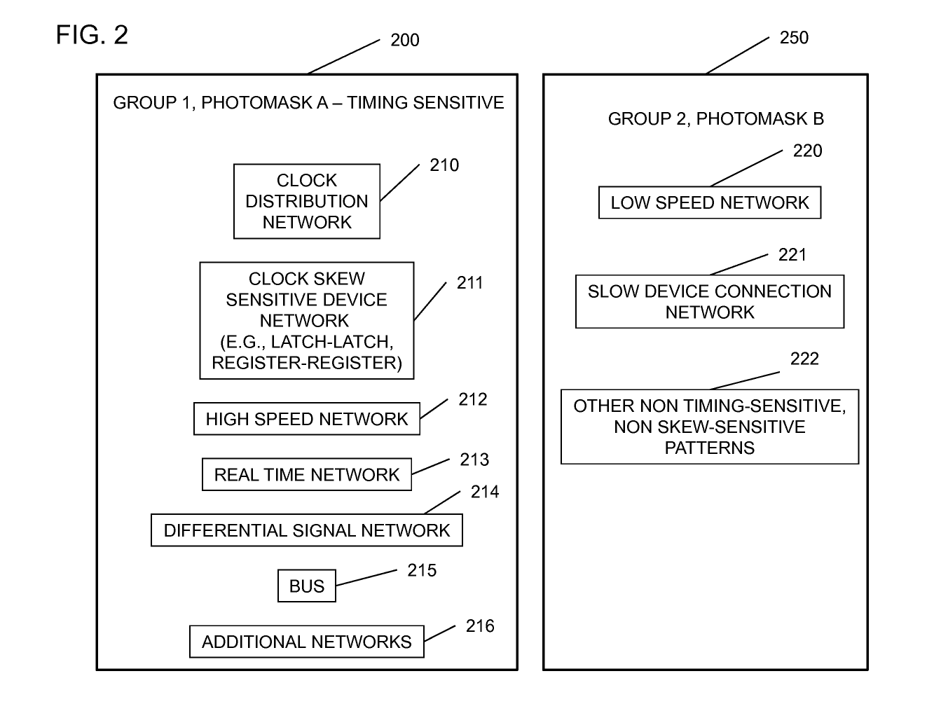

FIG. 2 schematically shows an arrangement of data to be input to the EDA tool for pre-grouping. In FIG. 2, two groupings are identified.

The first group 200 includes, but is not limited to, the timing critical networks. These may include at least a portion of the clock distribution network 210, may include the whole clock distribution network. In some embodiments, the first group 200 further comprises at least one pattern 216 adjacent to one of the patterns of the clock distribution network. The distance between the lines of the clock distribution network 210 and any adjacent lines in the adjacent networks 216 affect s the capacitive couplings and may affect timing. Thus, adding the adjacent networks 216 to the same photomask as the clock distribution network ensures that these distances and couplings are predictable and controllable, regardless of any misalignment between patterns formed by the first photomask and patterns formed by the second photomask.

The first group 200 may include all of the patterns adjacent to one of the patterns of the clock distribution network, or all of the patterns adjacent to any of the patterns of the clock distribution network. The first group 200 may include networks of clock skew sensitive devices 211 (such as networks connected between a source latch and a destination latch, where the source and destination latches are configured to receive a clock signal from the clock distribution network, and the destination latch is coupled to receive data from the source latch). In some embodiments, the first group includes real-time network patterns 213 coupled to transmit real-time signals, network patterns 212 coupled to transmit high speed signals, and network patterns 214 coupled to transmit differential signals. In some embodiments, the first group includes a system bus, instruction bus or database 215.

FIG. 2 also shows a second group 250 of patterns. The second group 250 may include a wide variety of patterns that are not timing critical, and are not sensitive to clock skew. Examples include, but are not limited to low speed networks 220 and networks 221 having slow device connections, among others 222.

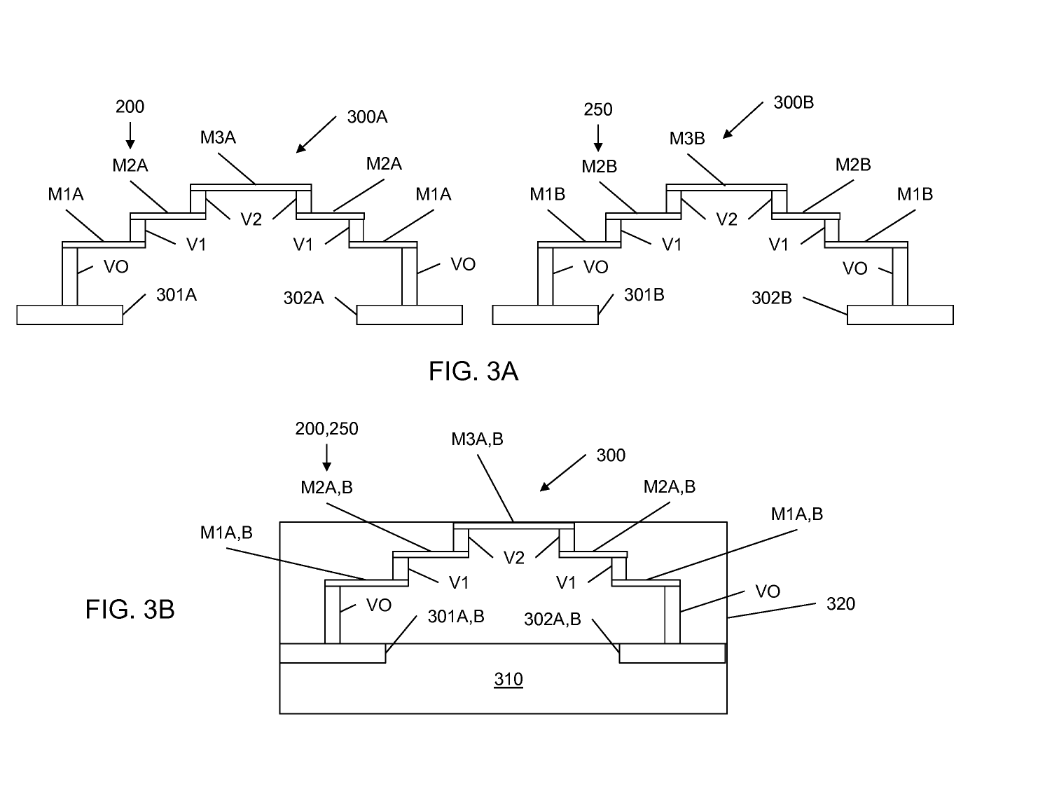

FIG. 3A schematically shows an example of a set of network s that are to be formed in the same IC by double patterning. In the example, the M1 layer patterns MIA and back end of line (BEOL) layer patterns M2A, M3A are formed above cells 301A and 302A, using a first set of masks. In addition, the M1 layer patterns M1B and BEOL metal layers M2B, M3B are formed above cells 301B and 302B, using a second set of masks. In one embodiment, all of the time critical networks 200 of FIG. 2 are routed in the M2 layer, using the M2A photomask. The non-timing critical networks in the M2 layer are formed using the second photomask M2B.

FIG. 3B shows an IC 300 formed by the photomasks of FIG. 3A. The IC 300 has a semiconductor substrate 310, in which the circuitry of cells 301A, 301B, 302A and 302B are formed. Above the substrate, the line layers M1, M2 and M3 and via layers V0, V1, and V2 are formed in the inter-metal dielectric (IMD) material 320. The completed IC has the MIA and

M1B patterns in the M1 layer, the M2A and M2B patterns in the M2 layer and the M3A and M3B patterns in the M3 layer. The timing critical patterns 200 and non-timing critical patterns are implemented in the same M2 layer, but the alignment between the timing-critical patterns 200 is maintained.

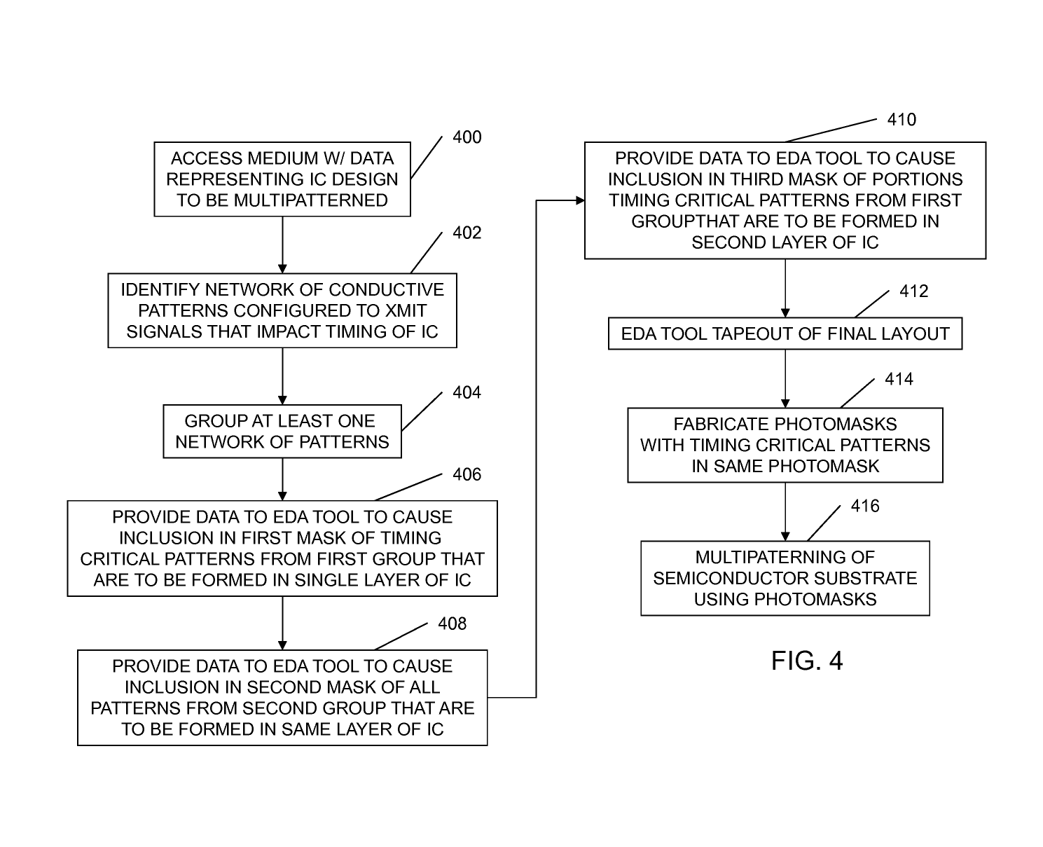

FIG. 4 is a flow chart of a method for laying out a multipatterned IC.

At step 400, a persistent, machine readable storage medium is accessed. The medium contains data representing an integrated circuit (IC) design to be fabricated using multi-patterning.

At step 402, at least one network of conductive patterns are identified. The identified patterns are configured to transmit signals that substantially impact timing of at least one circuit in the IC.

At step 404 pre—the at least one network of conductive patterns are grouped in a first group.

At step 406, data are electronically provided to an electronic design automation (EDA) tool to cause inclusion in a first single photomask of all portions of the patterns within the first group that are to be formed in a single layer of the IC. The single layer is to be multi-patterned using at least two photomasks. The electronically provided data cause the EDA tool to lay out the first group of patterns (including the timing critical patterns) with a spacing between each adjacent one of the first group of patterns greater than or equal to a minimum separator distance for patterns to be included in the first single photomask. The electronically providing step may include accessing a local persistent storage medium with a programmed processor, and loading the data into the main memory, cache memory, or registers of the processor. Alternatively, the data may be transmitted from one or more remote processors and/or persistent storage media by way of a telecommunications network, which may be a personal area network (PAN), local area network (LAN), wide area network (WAN), or a global telecommunications network, such as the Internet.

Within a single timing-critical network, the patterns are all pre-grouped (assigned to the same group). In some embodiments, two or more of the timing-critical networks are each assigned to a respective group, and both groups are formed on the photomask.

In other embodiments, two or more of the timing-critical networks are optionally each assigned to a respective group, and each group is formed on a respective photomask, for patterning the same layer of the IC. For example, at step 408, the second network of timing-critical conductive patterns, configured to transmit signals that substantially impact timing of the at least one circuit in the IC, are pre-grouped in a second group. The electronically provided data identify the second network of conductive patterns for inclusion in the second photomask. In one example, all the patterns in the clock distribution network may be assigned to a first photomask, and all the patterns in a real time network may be assigned to a second mask that is different from the first photomask. Both of these masks may then be used to pattern the same layer of the IC.

At step 410, the electronically provided data optionally further include a third group of patterns. These data cause inclusion in a third single photomask of all timing critical portions of the patterns within the first group that are to be formed in a second layer of the IC. Thus, timing critical patterns within each group are on the same photomask, but two or more timing critical networks may each be assigned to a respective layer of the IC.

At step 412, when the layout is final, the design is taped out.

At step 414, the photomasks are fabricated, such that within each layer having timing critical patterns, the timing critical patterns are on the same photomask.

At step 416, the semiconductor substrate is patterned using the photomasks.

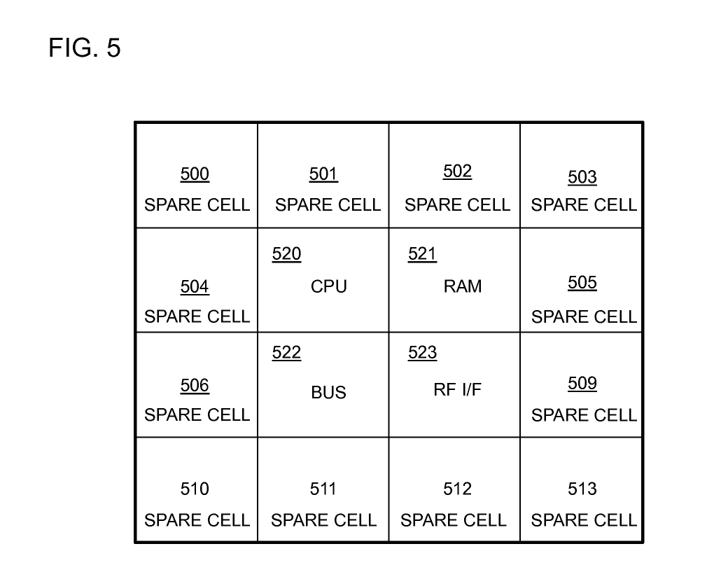

FIG. 5 is a schematic plan view of an IC having a plurality of function cells 520-523 and a plurality of spare cells 500-513 that are not connected to the function cells. The number and types of function cells 520-523 is optional, and any cells that are selected by the designer to perform the functions of the IC may be included. Thus, the set of function cells 520-523, including CPU 520, RAM 521, bus 522 ad RF interface 523 is only an example, and is not limiting. Similarly, the IC may include any number and any type of spare cell the designer chooses to include. The use of spare cells in ICs is generally described in U.S. Pat. No. 6,446,248, which is incorporated by reference herein.

One potential use of spare cells is to make design changes after silicon validation tests are performed, to correct or enhance function or performance. Such changes may be referred to as engineering change orders (ECO). At this stage, a full set of photomasks for the IC have already been fabricated, at considerable expense. To minimize the cost of the ECO, it is desirable to limit the changes to the smallest number of photomasks and/or the least expensive photomasks. In general, the photomasks for the metal interconnect layers (M1, M2, M3, . . . ) may be less expensive than the photomasks for the active device layers, because the dimensions of the active device layer photomasks are controlled very tightly, with smaller tolerances. Thus, it may be less expensive to implement the ECO by changing metal layer connections between cells. The active device layers of the spare cells are already part of the IC layout, so the ECO can be implemented in a “metal fix” by only changing one or more metal layer masks.

The inventors have determined that, if an IC is to be formed by MPT, it is possible to select an ECO solution that can be implemented in a single metal layer, but still affects more than one photomask. The inventor s have determined that, for implementing the metal fix within one layer, additional steps can be taken to limit the changes to one photomask in a single layer, or in some cases, one photomask per layer in two or more layers.

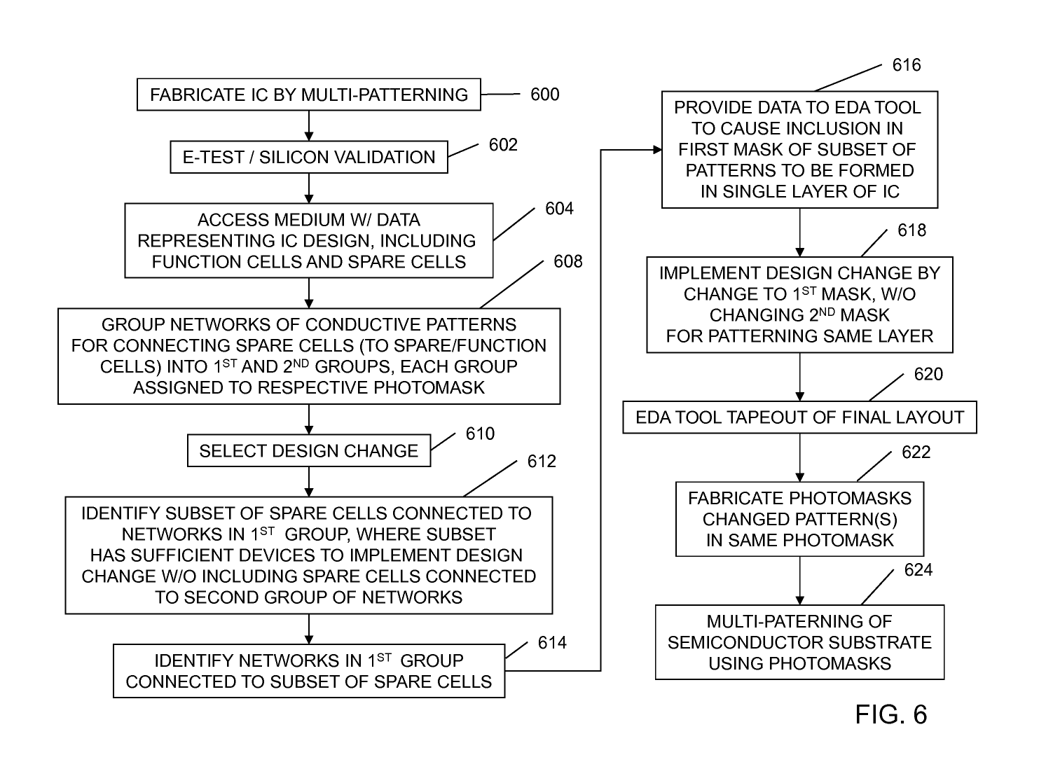

FIG. 6 is a flow chart of a method of implementing the ECO.

At step 600, an IC is fabricated for silicon validation.

At step 602, silicon validation is performed on the IC. A determination is made that an ECO is appropriate, to implement a design change in view of the results observed during the silicon validation.

At step 604, a persistent, machine readable storage medium is accessed. The medium contains data representing an integrated circuit (IC) design. The IC design includes a plurality of function cells 520-523 and a plurality of spare cells 500-513 that are not connected to the function cells.

At step 608 at least two networks of conductive patterns are grouped into first and second groups. Each network is configured to transmit signals between a respective one of the spare cells 500-513 and one of the group consisting of another one of the spare cells and one of the function cells 520-523. Each group is assigned to a respective photomask for multi-patterning the IC. For example, a first network for connecting a NAND gate of the active device layers may be included in the first group of networks to be formed using a first photomask, and a network for connecting a NOR gate of the active device layers may be included in the second group of networks to be formed using a second photomask. This is my no means limiting. Each group may include networks for connecting one or more of any type of device. Also, a given type of device may be instantiated in multiple spare cells, such that one instantiation of the device is connected by network in the first group, and another instantiation of the device is connected by a network assigned to the second group. For example, both the first and second groups may include networks for connecting respectively different spare cells, each containing an instantiation of a NAND gate.

At step 610, the designer selects the design change to be made. This includes identification of a circuit to be added, deleted or modified, and the changes at the schematic level.

At step 612, a subset of spare cells connected to networks in the first group is identified. For example, as noted above, a given type of device may be instantiated in multiple spare cells, such that one instantiation of the device is connected by network in the first group, and another instantiation of the device is connected by a network assigned to the second group. In other cases, a given type of device may only be instantiated connected by networks in the first group. If the design change may be implemented using either a first subset of devices connected only to networks in the first group or a second subset of devices connected by networks in each of the first and second groups, then the first subset of devices is identified as the appropriate set of devices for implementing the design change.

At step 614, a subset of the first group of patterns that are connected to the first subset of spare cells are identified. The first subset of spare cells includes sufficient devices to implement the design change without including spare cells connected by way of the second group of patterns. Although the IC design includes patterns within the second group that are to be formed by a second photomask in the same single layer of the IC, the implementing step does not affect any of the patterns in the second group.

In the embodiment of FIG. 6, spare cell networks are assigned to both the first and second groups, and the determination of which group to use is made based on the ability to implement the whole ECO change using only networks from a single group. If both groups have spare cells sufficient to implement the ECO, the selection of the first or second group may be made using normal routing considerations, such as the lengths of the networks.

At step 616, data are electronically provided to an electronic design automation (EDA) tool to cause inclusion in a single photomask of at least one portion of the patterns within the first group, the portion of the patterns to be formed in a single layer of the IC, the single layer to be multi-patterned using at least two photomasks.

At step 618, the design change is implemented by changing a layout of one single first photomask, without changing a second mask that is used for multi-patterning the same layer as the first photomask.

At step 620, the EDA tool makes a tapeout of the final changed mask.

At step 622, the photomask(s) for implementing the design change is fabricated. In some embodiments, the design change can be implemented by only changing the layout of a single photomask for a single multipatterned layer. In other embodiments, the design change may be implemented by only changing a single photomask for each respective one of two or more multipatterned layers. If it is considered appropriate to change a mask in more than one layer, the number of layers (and number of masks) is minimized.

At step 624, the layer of a substrate is patterned, to fabricate an IC according to the modified design, using the photomask made in step 622.

According to an alternative method, in which all of the spare cells are assigned to a single spare cell group, and spare cells are connected by all of the colors (photomasks). For each “part” of the IC design, the connections are routed by the same color (photomask) in each layer that carries connections for that part. For this purpose, the “part” may be as large as a function or as small as a device, such as a ring oscillator or a phase locked loop. With the baseline design locating all of the connections for a given “part” in the same color, the ECO is implemented by selecting spare cells capable of being connected by networks having the same color, and implementing the metal fix using those networks.

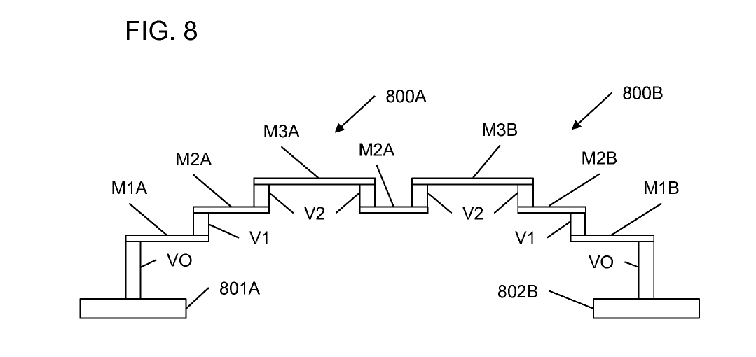

FIG. 8 shows an example of a portion of an IC having two parts 801A and 801B. The part 801A is connected by networks in the M1, M2 and M3 layers, which networks include patterns M1A, M2A and M3A respectively. The part 801B is connected by networks in the M1, M2 and M3 layers, which networks include patterns M1B, M2B and M3B respectively. Wherever possible, if an ECO affects part 801A, and spare cells are to be added to part 801A, then the change is implemented in a single layer, in a single one of the photomasks that forms one of the patterns M1A, M2A, or M3A. Similarly, wherever possible, if an ECO affects part 801B, and spare cells are to be added to part 801B, then the change is implemented in a single layer, in a single one of the photomasks that forms one of the patterns M1B, M2B, or M3B.

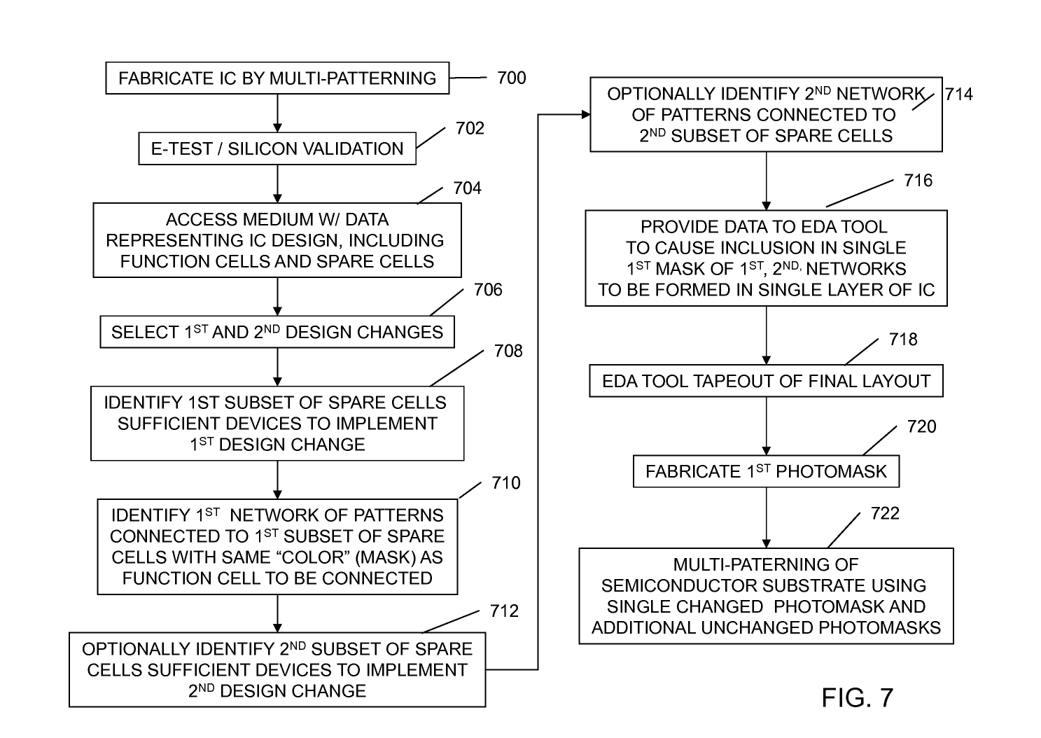

FIG. 7 is a flow chart of this embodiment of the method.

At step 700, an IC is fabricated for silicon validation.

At step 702, silicon validation is performed on the IC. A determination is made that an ECO is appropriate, to implement a design change in view of the results observed during the silicon validation.

At step 704, a persistent, machine readable storage medium is accessed. The medium contains data representing an integrated circuit (IC) design. The IC design includes a plurality of function cells 520-523 and a plurality of spare cells 500-513 that are not connected to the function cells.

At step 706, a first design change is selected, affecting a first part of the design. Optionally, a second design change is also selected.

At step 708, a first subset of spare cells is selected, including sufficient devices to implement the first design change in the IC design. Given the color of the patterns used to connect the function cells of the first part of the original design, the first subset is selected so that the first subset of spare ells can be connected to the function cells of the first part using patterns of the same color.

At step 710, at least one network of conductive patterns is identified, to connect the first subset spare cells to a first subset of the function cells.

At step 712, optionally, a second subset of spare cells is selected, including sufficient devices to implement a second design change in the IC design. If the second design change also affects the same first part as the first design change, then the second subset is selected so that the second subset of cells can be connected by network(s) of patterns having the same color as used to connect the first subset of spare cells.

At step 714, if step 712 is performed, a second network of conductive patterns is identified, to connect the second subset spare cells to a second subset of the function cells. The second network has the same color as the first network (so as to be formed on the same photomask).

At step 716, data are electronically provided to an EDA tool to cause inclusion of at least the first network of conductive patterns in a first single photomask that is used to pattern a layer of the IC, wherein the layer is to be multi-patterned using at least one additional photomask. This first photomask is also the same photomask used to route patterns to connect the function cells of the first part in the original IC design. None of the first or second subsets of networks is included in the additional photomask. Optionally, If steps 712 and 714 are performed, data are provided to the EDA tool to cause inclusion of the second network of conductive patterns in the first single photomask that is used to pattern the same layer of the IC.

At step 718, the EDA tool makes a tapeout of the final changed mask.

At step 720, the photomask(s) for implementing the design change is fabricated. In some embodiments, the design change can be implemented by only changing the layout of a single photomask for a single multipatterned layer. In other embodiments, the design change may be implemented by only changing a single photomask for each respective one of two or more multipatterned layers. If it is considered appropriate to change a mask in more than one layer, the number of layers (and number of masks) is minimized.

At step 722, the layer of a substrate is patterned, to fabricate an IC according to the modified design, using the photomask made in step 720.

Although not shown in FIG. 7, a third design change may also be identified affecting a second part, where the second part has function cells connected by networks formed in the same layer as the first network. However, the networks connecting the function cells of the second part are formed by a second photomask and are assigned a different color from the first network. The third design change is implemented by selecting a third subset of spare cells that can be connected by network(s) in formed by the second photomask. The third subset of spare cells is then connected by selecting network(s) having the different color, to be formed by the second photomask.

Thus all original pattern networks connecting the components of a first part, and all pattern networks used to connect spare cells to the components of the same part are assigned the same color and formed by a single photomask within a given layer. All original pattern networks connecting the components of a second part, and all pattern networks used to connect spare cells to the components of the second part are assigned the same color as each other and formed by a single photomask within a given layer. The color assigned for the second part and its spare cells may be the same as, or different from, the color assigned to the first part and its spare cells.

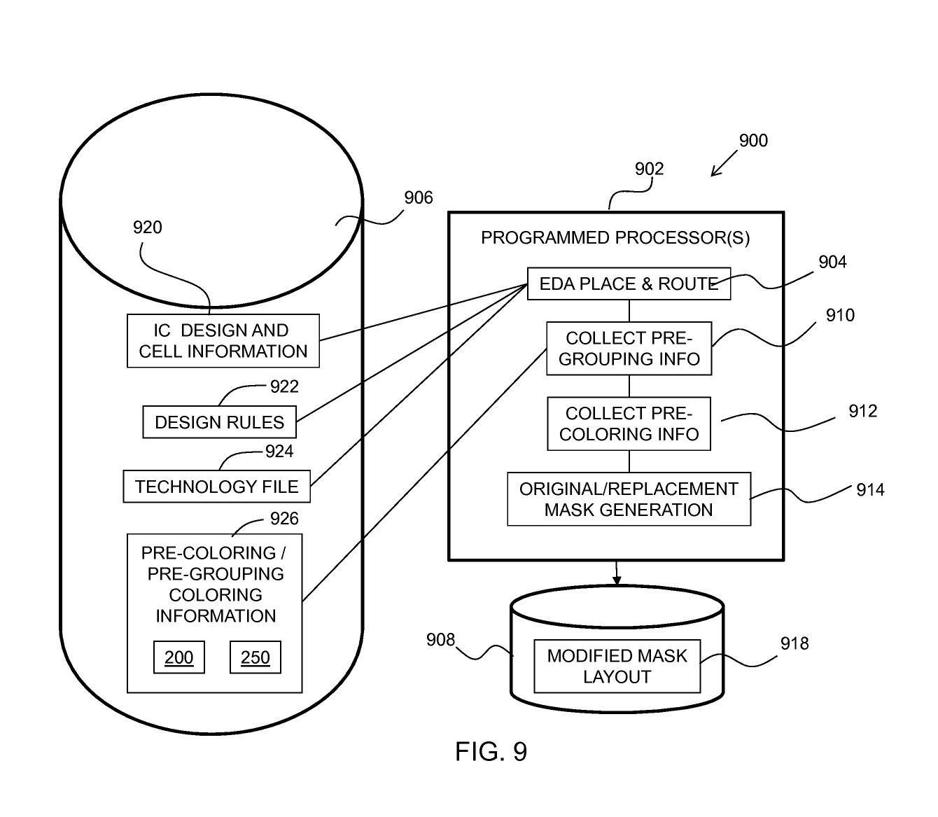

FIG. 9 is a block diagram of one example of a system for performing the method.

The system includes one or more programmed processors 902 configured to execute computer program code, such that when the processor executes the program code, the logic circuits of processor becomes a special purpose tool 900 for electronic design automation. Although only a single processor 902 is shown, the system may include any number of processors cooperatively performing different portions of the tasks described herein. If plural processors are included, they may be coupled to each other by shared memory, personal area network (PAN), local area network (LAN), wide area network (WAN), or a global telecommunications network, such as the Internet. The processor 902 may include one or more computers and/or one or more embedded processors. The processor 902 may include a processor resource provided by a commercial “cloud” processing service.

An EDA place and route tool 904 such as “IC COMPILER”™, sold by Synopsis, Inc. of Mountain View, Calif., including a router such as “ZROUTE”™, also sold by Synopsis. Other EDA tools may be used, such as the “ VIRTUOSO” custom design platform or the Cadence “ENCOUNTER”® digital IC design platform may be used, along with the “VIRTUOSO” chip assembly router, all sold by Cadence Design Systems, Inc. of San Jose, Calif. The EDA tool 904 is a special purpose computer formed by retrieving stored program instructions from a persistent computer readable storage medium 906 and executing the instructions on the general purpose processor 902.

One or more computer readable storage media 906 are provided to store input data used by the EDA tool 110. The router 120 is capable of receiving an IC design 920, including identification of a plurality of cells to be included in an IC layout, and a list of pairs of cells within the plurality of cells to be connected to each other. Also provided in the medium 906 are a set of design rules 922 and a technology file 924 which provide technology node dependent parameters and rules used by the foundry, such as a minimum separator distance between adjacent patterns. The design rules 922 and a technology file 924 provide the constraints that govern how the router lays out the connecting patterns.

Also provided is the user's pre-coloring/pre-grouping information 926. This information can include either or both of pre-coloring and pre-grouping information. In FIG. 9, the pre-grouping information assigning the groups 200 and 250 (FIG. 2) is included. The user's information 926 can identify first and second groups 200, 250 of patterns to be assigned to the first and second colors (photomasks), respectively, within a given layer. The information 926 can further comprises grouping information for implementing a design change pursuant to an ECO.

The processor is configured with a module 910 to collect the user's pre-grouping information, and a module 920 to collect the user's pre-coloring information. Each of these modules provides a graphical user interface (GUI) to display a portion of a schematic or layout to the user. For module 910, the GUI permits the user to select a plurality of patterns to be pre-grouped into the same unspecified color. For module 920, the GUI permits the user to select a plurality of patterns to be pre-colored and assigned the same specified color, for controlling whether plural groups are assigned to same or different colors (photomasks) from each other.

Block 914 incorporates the pre-grouping and pre-coloring information, completes the modifications to the routing, and provides design rule checks and layout versus schematic checks on any modifications to the layout, according to EDA tool principles.

Block 908 includes a persistent machine readable storage medium for storing the modified mask layout 918. Although FIG. 9 shows two media 906 and 908, any number of media may be used for storing the various data. The data may be stored in a variety of locally attached storage devices, remotely located devices accessible via a computer network, or storage provided by a commercially available “cloud” storage service.

In some embodiments, a method comprises: accessing a persistent, machine readable storage medium containing data representing an integrated circuit (IC) design to be fabricated using multi-patterning; identifying at least one network of conductive patterns configured to transmit signals that substantially impact timing of at least one circuit in the IC; pre-grouping the at least one network of conductive patterns in a first group; and electronically providing data to an electronic design automation (EDA) tool to cause inclusion in a first single photomask of all portions of the patterns within the first group that are to be formed in a single layer of the IC, wherein the single layer is to be multi-patterned using at least two photomasks.

In some embodiments, a method comprises: accessing a persistent, machine readable storage medium containing data representing an integrated circuit (IC) design, the IC design including a plurality of function cells and a plurality of spare cells that are not connected to the function cells; selecting the design change; selecting a first subset of spare cells including sufficient devices to implement a design change in the IC design; identifying at least one network of conductive patterns to connect the first subset spare cells to a first subset of the function cells; and electronically providing data to an electronic design automation (EDA) tool to cause inclusion of the at least one network of conductive patterns in a first single photomask that is used to pattern a layer of the IC, wherein the layer is to be multi-patterned using at least one additional photomask.

In some embodiments, a method comprises: accessing a persistent, machine readable storage medium containing data representing an integrated circuit (IC) design, the IC design including a plurality of function cells and a plurality of spare cells that are not connected to the function cells; grouping at least two networks of conductive patterns into first and second groups, each network configured to transmit signals between a respective one of the spare cells and one of the group consisting of another one of the spare cells and one of the function cells, each group assigned to a respective photomask for multi-patterning the IC; and implementing a change in the IC design to connect one of the spare cells to one of the function cells by way of one or more of the first group of networks.

The system may be at least partially embodied in the form of computer-implemented processes and apparatus for practicing those processes. The system may also be at least partially embodied in the form of computer program code embodied in tangible, persistent machine readable storage media, such as random access memory (RAM), read only memories

(ROMs), CD-ROMs, DVD-ROMs, BD-ROMs, hard disk drives, flash memories, or any other machine-readable storage medium, wherein, when the computer program code is loaded into and executed by a computer, the computer becomes an apparatus for practicing the invention. The system may also be embodied at least partially in the form of computer program code, for example, whether stored in a persistent storage medium, loaded into and/or executed by a computer, such that, when the computer program code is loaded into and executed by the computer, the computer becomes an apparatus for practicing the method. When implemented on a general-purpose processor, the computer program code segments configure the processor to create specific logic circuits. The system may alternatively be at least partially embodied in a digital signal processor formed of application specific integrated circuits for performing a method according to the principles described above.

Although the subject matter has been described in terms of exemplary embodiments, it is not limited thereto. Rather, the appended claims should be construed broadly, to include other variants and embodiments, which may be made by those skilled in the art.

What is claimed is:

1. A method comprising:
accessing a persistent, machine readable storage medium containing data representing an integrated circuit (IC) design to be fabricated using multi-patterning;
identifying at least one network of conductive patterns configured to transmit signals that substantially impact timing of at least one circuit in the IC;
pre-grouping the at least one network of conductive patterns in a first group; and
electronically providing data to an electronic design automation (EDA) tool to cause inclusion in a first single photomask of all portions of the patterns within the first group that are to be formed in a single layer of the IC, wherein the single layer is to be multi-patterned using at least two photomasks.

2. The method of claim 1, wherein the first group includes at least a portion of a clock distribution network of the IC.

3. The method of claim 2, wherein the first group further comprises at least one pattern adjacent to one of the patterns of the clock distribution network.

4. The method of claim 2, wherein the first group further includes a plurality of devices, the operation of which is sensitive to clock skew.

5. The method of claim 2, wherein the first group further includes a source latch and a destination latch, the source and destination latches configured to receive a clock signal from the clock distribution network, the destination latch coupled to receive data from the source latch.

6. The method of claim 1, wherein the first group includes patterns coupled to transmit at least one of the group consisting of real-time signals, high speed signals, and differential signals.

7. The method of claim 1, wherein the first group includes patterns connected to a data bus.

8. The method of claim 1, wherein the electronically provided data cause the EDA tool to lay out the first group of patterns with a spacing between each adjacent one of the first group of patterns greater than or equal to a minimum separator distance for patterns to be included in the first single photomask.

9. The method of claim 1, wherein the electronically provided data further cause inclusion in a second single photomask of all portions of the patterns within the first group that are to be formed in a second layer of the IC, wherein the second layer is to be multi-patterned using at least two additional photomasks.

10. The method of claim 1, further comprising:
identifying a second network of conductive patterns configured to transmit signals that substantially impact timing of the at least one circuit in the IC;
pre-grouping the second network of conductive patterns in a second group;
wherein the electronically provided data further cause inclusion in the single photomask or an additional single photomask of all portions of the patterns within the second group that are to be formed in the first layer of the IC.

11. A method comprising:
accessing a persistent, machine readable storage medium containing data representing an integrated circuit (IC) design, the IC design including a plurality of function cells and a plurality of spare cells that are not connected to the function cells;
grouping at least two networks of conductive patterns into first and second groups, each network configured to transmit signals between a respective one of the spare cells and one of the group consisting of another one of the spare cells and one of the function cells, each group assigned to a respective photomask for multi-patterning the IC; and
implementing a change in the IC design to connect one of the spare cells to one of the function cells by way of one or more of the first group of networks.

12. The method of claim 11, wherein the implementing step includes electronically providing data to an electronic design automation (EDA) tool to cause inclusion in a single photomask of at least one portion of the patterns within the first group, the portion of the patterns to be formed in a single layer of the IC, the single layer to be multi-patterned using at least two photomasks

13. The method of claim 11, further comprising selecting the design change;
identifying a subset of the first group of patterns that are connected to a first subset of spare cells, the first subset of spare cells including sufficient devices to implement the design change without including spare cells connected by way of the second group of patterns.

14. The method of claim 13, wherein the implementing step is performed after silicon validation

15. The method of claim 11, wherein the electronically provided data causes the EDA tool to implement the design change by changing the layout of single photomask.

16. The method of claim 11 wherein the IC design includes patterns within the second group that are to be formed by a second photomask in the same single layer of the IC, and the implementing step does not affect any of the patterns in the second group.

17. A method comprising:
accessing a persistent, machine readable storage medium containing data representing an integrated circuit (IC) design, the IC design including a plurality of function cells and a plurality of spare cells that are not connected to the function cells;
selecting the design change;
selecting a first subset of spare cells including sufficient devices to implement a design change in the IC design;
identifying at least one network of conductive patterns to connect the first subset spare cells to a first subset of the function cells; and
electronically providing data to an electronic design automation (EDA) tool to cause inclusion of the at least one network of conductive patterns in a first single photomask that is used to pattern a layer of the IC, wherein the layer is to be multi-patterned using at least one additional photomask.

18. The method of claim 17, further comprising:
selecting a second subset of spare cells including sufficient devices to implement a second design change in the IC design;
identifying at least a second network of conductive patterns to connect the second subset of spare cells to a second subset of the function cells; and
electronically providing data to the electronic design automation (EDA) tool to cause inclusion of the second network of conductive patterns in the first single photomask that is used to pattern the same layer of the IC.

19. The method of claim 18, wherein the electronically provided data configure the EDA tool so that:
none of the first or second subsets of networks is included in the additional photomask.

20. The method of claim 18, wherein the method is performed after silicon validation of the IC design.
